(19) United States
(12) Patent Application Publication
(10) Pub. No.: US 2006/0098102 A1
(43) Pub. Date: May 11, 2006

(54) Surveillance system for controlling camera, monitor and extra device using remote controller

(75) Inventor: Jae-seok Lee, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/984,872

(22) Filed: Nov. 10, 2004

(51) Int. Cl. H04N 5/232

(52) U.S. Cl. 348/211.99

(57) ABSTRACT

A surveillance system capable of controlling a camera, a monitor, and an extra device using a single remote controller. The electronic device for receiving a video signal transferred from a photographing device and for outputting the video signal to an extra device includes: an input section inputting a control command for controlling the extra device; a controller outputting a control signal corresponding to the control command; and a communication interface receiving the control signal and transferring the received control signal to the extra device.

### BACKGROUND OF THE INVENTION

1. Field of the Invention

The present invention relates to a surveillance system. More specifically, the present invention relates to a surveillance system including a camera, a monitor and an extra device controlled by a remote controller.

2. Description of Related Art

With the development of data transfer technology, it is possible to view a video photographed by and transferred from a photographing device at a place remote from the photographing device. For example, by installing a closed circuit television (CCTV) at a desired location, personnel can watch the area through a monitor in an office. Thus, for example, by installing a camera over a traffic congestion area, personnel can observe in a central control room the traffic flow in the area.

FIG. 1 is a block diagram of a conventional surveillance system. Referring to FIG. 1, the surveillance system includes a CCTV camera 10, a monitor 20, and a VCR (video cassette recorder) 30. The conventional system also includes a remote controller 23 for remotely controlling the monitor 20 and a VCR remote controller 23 for remotely controlling the VCR 30.

The CCTV camera 10 is installed in an area to be monitored and transfers to the monitor 20 a video signal generated by photographing the monitored area. The monitor 20 signal-processes and displays the video signal received from the CCTV camera 10 so that the status of the monitored area can be observed.

The photographed video image of the monitored area is stored using the VCR 30, and therefore, it is possible to reproduce and search the stored video image. To this end, the monitor 20 retransmits to the VCR 30 the video signal received from the CCTV camera 10, and the VCR 30 records the video signal received from the monitor 20 on a recording medium.

When setting an environment or a function configuration of the monitor 20, a user needs to input a setup command through a key input part (not shown) usually disposed on a front side of the monitor 20 or a monitor remote controller signal receiver 21 by use of the monitor remote controller 23.

When recording the photographed video image, reproducing the recorded video image, or setting the environment or function configuration of the VCR 30, the user needs to input an setup command through a key input part (not shown) usually disposed on a front side of the VCR 30 or a VCR remote controller signal receiver 31 by use of the VCR remote controller 33.

Thus, the user experiences inconvenience of utilizing the key input parts or separately the remote controllers 23 and 33 when setting the environment or function configuration of the monitor 20 and the VCR 30.

### BRIEF SUMMARY

To overcome the above disadvantage of the conventional arrangement and/or other disadvantages, an exemplary aspect of the present invention provides a surveillance system capable of controlling a camera, a monitor, and an extra device using a single remote controller.

According to an aspect of the present invention, there is provided an electronic device for receiving a video signal transferred from a photographing device and for outputting the video signal to an extra device, including: an input section for inputting a control command for controlling the extra device; a controller for outputting a control signal corresponding to the control command; and a communication interface for receiving the control signal and for transferring the received control signal to the extra device.

The input section may include a remote controller for inputting the control command; and a receiver for receiving the control command input through the remote controller and for forwarding the received control command to the controller.

The control command may relate to one of an environment configuration and a function configuration of the extra device.

The recording device may include a recording device communication interface for receiving the control signal from the communication interface; and a recording device controller for executing the control command corresponding to the control signal input from the recording device communication interface.

According to another aspect of the present invention, there is provided a surveillance system including: a photographing device; an electronic device for receiving a video signal transferred from the photographing device; and a recording device for recording the video signal transferred to the electronic device. The electronic device includes an input section for inputting a control command to control one of the photographing device and the recording device, a controller for outputting a control signal corresponding to the control command, and a communication interface for receiving the control signal output from the controller and for transferring the received control signal to one of the photographing device and the recording device.

The photographing device may include a photographing device communication interface for receiving the control signal from the communication interface, and a photographing device controller for executing the control command corresponding to the control signal.

In the surveillance system comprising a photographing device, an electronic device for receiving a video signal transferred from the photographing device, and a recording device for recording the video signal transferred from the electronic device, the electronic device comprises an input part for inputting a control command to control one of the photographing device and the recording device; a controller for outputting a control signal corresponding to the control command input through the input part; and a communication interface for receiving the control signal output from the controller and transferring the received control signal to one of the photographing device and the recording device.

The photographing device may include a photographing device communication interface for receiving the control signal from the communication interface, and a photographing device controller for executing the control command corresponding to the control signal input from the photographing device communication interface. The recording device may include a recording device communication interface for receiving the control signal from the communication interface, and a recording device controller for executing the control command corresponding to the control signal.

According to another aspect of the present invention, there is provided a system including: a photographic section outputting video signals; a recording section which records the video signals; and a display and control section which receives and displays the video signals. The display and control sections include a display, an image processor which processes input digital video signals for display on the display and which outputs digital video signals, a decoder which converts received analog video signals to digital video signals and which outputs the digital video signals to the image processor, a first switch which receives video signals from the photographic section and a reproducing signal from the recording section and which selectively outputs the received signals to the decoder, an encoder which converts digital video signals received from the image processor into analog video signals and which outputs the analog video signals to the display and to a second switch which selectively transfers the analog video signals to more than one of a slave monitor, a spot monitor, and the recording section and which transfers a recording control signal to the recording section, and a main controller which controls the photographic section, the recording section, the image processor, the encoder, and the second switch.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a block diagram of a conventional surveillance system; and

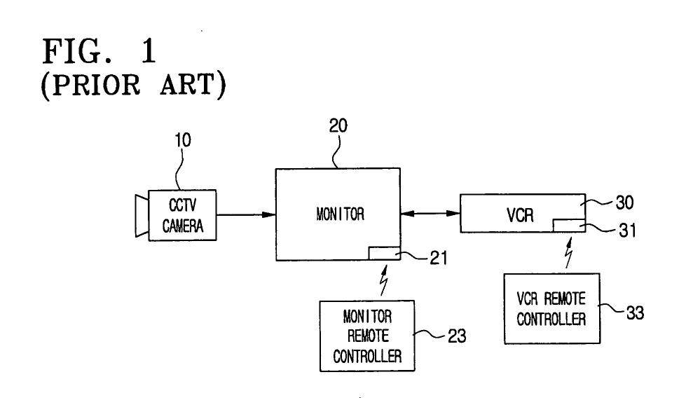

FIG. 2 is a block diagram of a surveillance system capable of controlling a camera, a monitor, and an extra device using a single remote controller according to an embodiment of the present invention.

### DETAILED DESCRIPTION OF EMBODIMENT

Reference will now be made in detail to an embodiment of the present invention, examples of which are illustrated in the accompanying drawings, wherein like reference numerals refer to the like elements throughout. The embodiment is described below in order to explain the present invention by referring to the drawings.

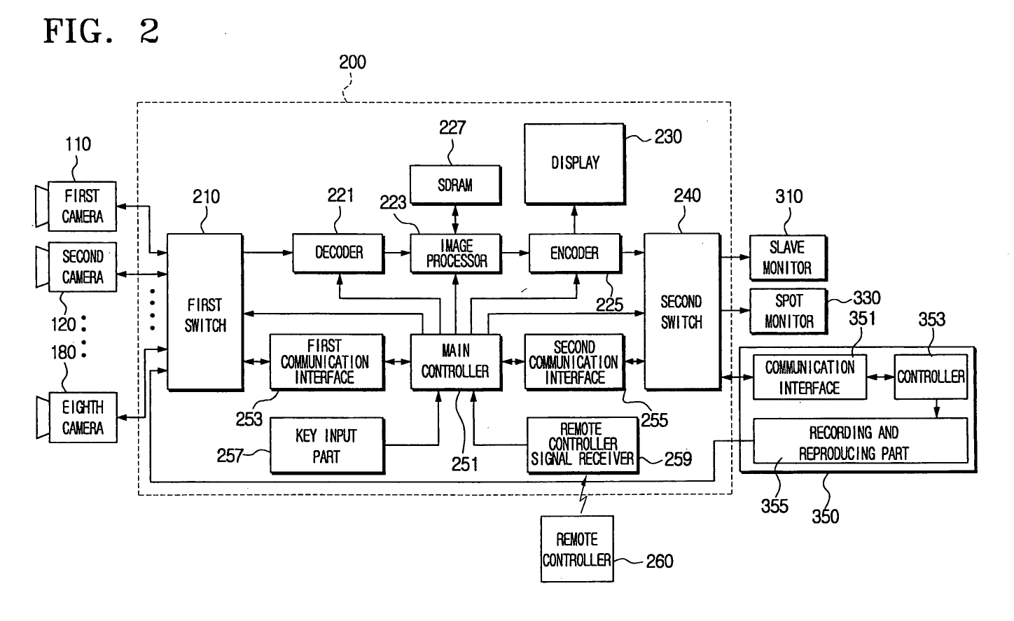

FIG. 2 is a block diagram of a surveillance system capable of controlling a camera, a monitor, and an extra device using a single remote controller according to an embodiment of the present invention. Referring to FIG. 2, the surveillance system includes a plurality of cameras 110 to 180, a security monitor 200, a slave monitor 310, a spot monitor 330, and a DVR (digital video recorder) 350.

The DVR 350 is a recording and reproducing device which records an incoming video signal on an embedded recording medium, and reproduces the recorded video signal. The slave monitor 310 displays the same video as displayed on a display 230, to be explained below. The spot monitor 330 is installed to display a video transferred from a particular camera 110 to 180.

The plurality of the cameras 110 to 180 may be installed in different monitoring areas or in a single monitoring area to photograph the area from various angles. The cameras 110 to 180 may be connected to the security monitor 200 through RJ-45 (registered jack-45) cables. The cameras 110 to 180 may be supplied with power from the security monitor 200.

The security monitor 200 receives and displays the video signals of the cameras 110 to 180. The security monitor 200 includes a first switch 210, a decoder 221, an image processor 223, an encoder 225, a SDRAM (synchronous dynamic random access memory) 227, the display 230, a second switch 240, a main controller 251, respective first and second communication interfaces 253 and 255, a key input part 257, and a remote control signal receiver 259.

The first switch 210 receives the video signal from the cameras 110 to 180 and a reproducing signal output from the DVR 350, and selectively outputs the received signals to the decoder 221. The first switch 210 switches to transfer a camera control signal output through the first communication interface 253 to one of the cameras 110 to 180.

The decoder 221 converts analog video signals received from the cameras 110 to 180 through the first switch 210, to digital video signals and outputs the digital video signals to the image processor 223. The decoder 221 also converts analog video signals reproduced and output from the DVR 350 to digital video signals, and outputs the digital video signals to the image processor 223.

The image processor 223 performs image processing with respect to the digital video signals input from the decoder 221. The image processor 223, under the control of the main controller 251, processes to display only one of the video signals transferred from the cameras 110 to 180 on the display 230, processes to display a plurality of videos by splitting a screen of the display 230, or processes to display the plurality of the videos in sequence at certain time intervals. Such a processing is realized by controlling the output of the digital video signals from the decoder 221 to the encoder 225. The SDRAM 227 is used as a buffer while the image processor 223 processes the input digital video signals.

The encoder 225, under the control of the main controller 251, converts the digital video signals received from the image processor 223 to analog video signals, and outputs the analog video signals to the display 230 and the second switch 240.

The display 230 displays the analog video signals received from the encoder 225. According to the image processing of the image processor 223, the display 230 displays the single video, or, the plurality of the videos on the split screen or on the single screen in sequence at the certain time intervals.

The second switch 240, under the control of the main controller 251, switches to selectively transfer the analog video signals output from the encoder 225 to more than one of the slave monitor 310, the spot monitor 330, and the DVR 350. The second switch 240 switches to transfer a DVR control signal output from the second communication interface 255 to the DVR 350.

The key input part 257 is disposed on a front portion of the security monitor 200, and transfers an operation command of the user to the main controller 251. The remote controller signal receiver 259 transfers an operation command input by the user through the remote controller 260, to the main controller 251.

The user is able to set the environment or function configuration of the security monitor 200 as well as the cameras 110 to 180 and the DVR 350 by use of the remote controller 260 of the security monitor 200, to be explained in further detail below.

The following is on the environment and function configurations of the cameras 110 to 180. Each of the cameras 110 to 180 can perform functions such as zoom-in and zoom-out, auto-focus, auto-iris, and pan and tilt. The user calls a menu screen using keys on the remote controller 260, selects one of the cameras 110 to 180 on the menu screen, selects desired functions based on a function list displayed on the screen menu, and thus, executes the desired functions of the selected camera.

When the user inputs a set command of a certain function by operating the remote controller 260 as above, the remote control signal receiver 259 forwards the user's command output from the remote controller 260 to the main controller 251. The main controller 251 generates and outputs a control signal corresponding to the user's command to the first communication interface 253.

The first communication interface 253 can communicate with communication interfaces (not shown) respectively embedded in the cameras 110 to 180 according to the RS-485standard (Recommended Standard-485). Hence, the control signal is transferred from the first communication interface 253 to a communication interface (not shown) of the camera to be controlled by the user, and then, to a controller (not shown) of the camera. The controller of the camera controls its operation according to the control signal.

The DVR 350 also has a recording speed set function and an edit function with respect to the recorded video, in addition to the recording and reproduction functions of the photographed video signals. The user can execute such functions of the DVR 350 by calling the menu screen using the keys on the remote controller 260 and selecting desired functions based on the function list on the menu screen.

When the user inputs a set command of a certain function by operating the remote controller 260 as above, the remote controller receiver 259 forwards the user's command output from the remote controller 260 to the main controller 251. The main controller 251 generates and outputs a control signal corresponding to the user's command to the second communication interface 255.

The second communication interface 255 can communicate with a communication interface 351 embedded in the DVR 350 according to RS-485. Hence, the control signal is transferred from the second communication interface 255 to the communication interface 351, and then, to a DVR controller 353. The DVR controller 353 controls an operation of a recording and reproducing part 355 according to the control signal.

The above-described embodiment exemplifies, for understanding and not for limiting, the surveillance system which sets the environment or function configuration of the security monitor 200, the cameras 110 to 180, and the DVR 350 by use of the remote controller 260 of the security monitor 200. It should be appreciated that the environment or function configuration of the security monitor 200, the cameras 110 to 180, and the DVR 350 may be set by use of the key input part 257, instead of the remote controller 260 of the security monitor 200.

As described above, since the single remote controller enables the operation control of the cameras, the monitor, and the extra devices, the user does not have to use the key input part of each device and does not have to use remote controllers respectively for each device when setting the environment or function configuration of the devices.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An electronic device for receiving a video signal transferred from a photographing device and for outputting the video signal to an extra device, comprising:
an input section inputting a control command for controlling the extra device;
a controller outputting a control signal corresponding to the control command; and
a communication interface receiving the control signal and transferring the received control signal to the extra device.

2. The electronic device of claim 1, wherein the input section includes:
a remote controller inputting the control command; and
a receiver receiving the control command input through the remote controller and forwarding the received control command to the controller.

3. The electronic device of claim 1, wherein the control command relates to one of an environment configuration and a function configuration of the extra device.

4. A surveillance system comprising:
an electronic device receiving a video signal transferred from a photographing device; and
a recording device recording the video signal transferred from the electronic device,
wherein the electronic device includes
an input section inputting a control command to control the recording device,
a controller outputting a control signal corresponding to the control command, and
a communication interface receiving the output control signal and transferring the received control signal to the recording device.

5. The surveillance system of claim 4, wherein the input section includes:
a remote controller inputting the control command; and
a receiver receiving the control command input through the remote controller and forwarding the received control command to the controller.

6. The surveillance system of claim 4, wherein the control command relates to one of an environment configuration and a function configuration of the recording device.

7. The surveillance system of claim 4, wherein the recording device includes:
a recording device communication interface receiving the control signal from the communication interface; and
a recording device controller executing a control command corresponding to the control signal.

8. A surveillance system comprising:
a photographing device; and
an electronic device receiving a video signal transferred from the photographing device,
wherein the electronic device includes
an input section inputting a control command to control the photographing device,
a controller outputting a control signal corresponding to the control command, and
a communication interface receiving the output control signal and transferring the received control signal to the photographing device.

9. The surveillance system of claim 8, wherein the input section includes:
a remote controller inputting the control command; and
a receiver receiving the control command input through the remote controller and forwarding the received control command to the controller.

10. The surveillance system of claim 8, wherein the control command relates to one of an environment configuration and a function configuration of the photographing device.

11. The surveillance system of claim 8, wherein the photographing device includes:
a photographing device communication interface receiving the control signal from the communication interface; and
a photographing device controller executing a control command corresponding to the control signal.

12. A surveillance system comprising:
a photographing device;
an electronic device receiving a video signal transferred from the photographing device; and
a recording device recording the video signal transferred to the electronic device,
wherein the electronic device includes
an input section inputting a control command to control one of the photographing device and the recording device,
a controller outputting a control signal corresponding to the control command, and
a communication interface receiving the control signal output from the controller and transferring the received control signal to the photographing device or the recording device.

13. The surveillance system of claim 12, wherein the input part comprises:
a remote controller inputting the control command; and
a receiver receiving the control command input through the remote controller and forwarding the received control command to the controller.

14. The surveillance system of claim 12, wherein the control command relates to one of an environment configuration and a function configuration of the photographing device or the recording device.

15. The surveillance system of claim 12, wherein the photographing device includes:
a photographing device communication interface receiving the control signal from the communication interface; and
a photographing device controller executing a control command corresponding to the control signal input from the photographing device communication interface, and
wherein the recording device includes:
a recording device communication interface receiving the control signal from the communication interface; and
a recording device controller executing the control command corresponding to the control signal.

16. A system comprising:
a photographic section outputting video signals;
a recording section which records the video signals; and
a display and control section which receives and displays the video signals and which includes
a display,
an image processor which processes input digital video signals for display on the display and which outputs digital video signals,
a decoder which converts received analog video signals to digital video signals and which outputs the digital video signals to the image processor,
a first switch which receives video signals from the photographic section and a reproducing signal from the recording section and which selectively outputs the received signals to the decoder,
an encoder which converts digital video signals received from the image processor into analog video signals and which outputs the analog video signals to the display and to a second switch which selectively transfers the analog video signals to more than one of a slave monitor, a spot monitor, or the recording section and which transfers a recording control signal to the recording section, and
a main controller which controls the photographic section, the recording section, the image processor, the encoder, and the second switch.

17. The system of claim 16, wherein the photographic section includes a plurality of cameras.

18. The system of claim 17, wherein the cameras are connected to the display and control section by cables.

19. The system of claim 17, wherein the cameras are supplied with power from the display and control section.

20. The system of claim 16, further comprising a buffer used by the image processor during image processing.

21. The system of claim 20, wherein the buffer is a synchronous dynamic random access memory.

22. The system of claim 16, wherein the image processor controls the output of the digital video signals from the decoder to the encoder.

23. The system of claim 16, further comprising a key input part which transfers an operation command to the main controller.

24. The system of claim 16, further comprising a remote control signal receiver which transfers the operation command input by the user through the remote controller to the main controller.

25. The system of claim 16, wherein the display displays one of the video signals, a plurality of the video signals by splitting a screen of the display, or the plurality of the video signals in sequence at certain time intervals

26. The system of claim 16, wherein the slave monitor displays the same video signal as the display.

27. The system of claim 16, wherein the spot monitor displays a specified video signal

28. The system of claim 16, wherein the recording section includes a digital video recorder.

29. The system of claim 16, wherein the main controller controls the photographic section, the recording section, and the display and control section based on an input from a remote controller.
